(19) United States
(12) Patent Application Publication
(10) Pub. No.: US 2013/0026386 A1
(43) Pub. Date: Jan. 31, 2013

(54) ELECTROLYTIC PLATING METHOD AND ELECTROSTATIC DEFLECTING DEVICE

(71) Applicant: Kazushige Utsumi, Sagamihara-shi (JP)

(72) Inventor: Kazushige Utsumi, Sagamihara-shi (JP)

(73) Assignee: CANON KABUSHIKI KAISHA, Tokyo (JP)

(21) Appl. No.: 13/486,196

(22) Filed: Jun. 1, 2012

(30) Foreign Application Priority Data
Jul. 27, 2011 (JP) 2011-164773

(51) Int. Cl. H01J 3/26; C25D 5/02

(52) U.S. Cl. 250/396 R; 205/135

(57) ABSTRACT

Disclosed is an electrolytic plating method which includes forming plating films 5 and 6 having predetermined thicknesses in a plurality of regions 14 and 15 on a substrate 1. The electrolytic plating method includes arranging a resistive element 4 having ohmic characteristics in at least one of paths through which electrolytic plating currents flow into the plurality of the regions 14 and 15 on the substrate 1, respectively, and simultaneously growing the plating films 5 and 6 in the plurality of the regions 14 and 15 by electrolytic plating. The electrolytic plating method can form the plating films having different or same thicknesses in the plurality of the regions on the substrate.

### BACKGROUND OF THE INVENTION

1. Field of the Invention

The present invention relates to an electrolytic plating method of independently controlling electrolytic plating currents to be supplied to a plurality of regions on a substrate, and an electrostatic deflecting device which is manufactured by using the method.

2. Description of the Related Art

A pattern plating technology is known which limits a region in which a plating film grows by a resist pattern. A growing speed of the film by electrolytic plating is determined by an amount of electric charges per unit area and unit period of time, which are supplied to a substrate surface, in other words, by a current density. On the other hand, in many cases, it is desirable for a structure formed by pattern plating to have a uniform height within the substrate. In order to form such a structure, many methods are devised for enhancing the uniformity of the current density within the surface as much as possible. If such a method is applied to the pattern plating, the electrolytic plating current becomes almost uniform within the substrate, and plating films of adjacent patterns in the substrate, for instance, result in acquiring almost equal thicknesses.

On the other hand, there also some cases in which it is desirable for plating films of adjacent patterns to have different heights from the viewpoint of a function of a structure. Thus, when the heights of adjacent patterns are differentiated from each other, it is difficult to realize a structure by one time of pattern plating treatment in which an almost uniform electrolytic plating current flows to a substrate as has been described above. For instance, such a method is adopted as to realize two different heights by growing the plating films by two separated plating treatments. However, in the method of separating the plating treatment into two times, a pattern formed in the 1st time may cause a failure when a pattern is formed in the 2nd time. For instance, an application failure of a resist is occasionally caused in a photolithography for forming the pattern of the 2nd time, by the existence of the pattern formed in the 1st time.

In view of the above described problems, such a method is proposed as to realize adjacent patterns having different heights by one time of the pattern plating treatment. Japanese Patent No. 3583878 discloses a technology of controlling the current density by forming a pn junction on a semiconductor substrate, making the pn junction function as a rectifying element, and adjusting voltage to be applied to the substrate in electrolytic plating treatment. In addition, Japanese Patent No. 3843919 discloses a technology of controlling the current density by providing a dummy pattern and densifying a pattern density around a certain particular pattern, when forming a pattern on a substrate by plating.

However, according to the method described in Japanese Patent No. 3583878, a ratio of the current density at a portion in which a rectifying element is connected to that at a portion in which a rectifying element is not connected varies depending on applied voltage. Accordingly, according to this technology, when the ratio of the current densities is fixed at a certain value, an applied voltage and a consequent plating current are fixed to certain values, and there is the case in which the growing speed of the plating film cannot be determined freely. In addition, it can occur that only the electric signal can be transmitted which has a form of having been rectified to a half-wave current of an either positive or negative side according to current-voltage characteristics of the rectifying element. Furthermore, the method described in Japanese Patent No. 3843919 includes providing the dummy pattern, and accordingly can result in giving restrictions on a pattern arrangement on the substrate. For this reason, a conventional method of forming plating films having different thicknesses on a plurality of regions on the substrate with the electrolytic plating method has had restriction on any one of voltage to be applied in electrolytic plating, an electric signal to be transmitted to a formed electrode and a pattern layout.

### SUMMARY OF THE INVENTION

According to an aspect of the present invention, an electrolytic plating method for forming a plating film of a predetermined thickness in a plurality of regions on a substrate comprises steps of; arranging a resistive element with an ohmic characteristics in at least a part of a plurality of paths through which an electrolytic plating current flows into the plurality of regions, and growing an electroplating film by electroplating simultaneously in the plurality of regions.

According to a further aspect of the present invention, an electrolytic plating method for forming an electrostatic deflecting device having electrodes of different thicknesses in a plurality of regions on a substrate comprises steps of; arranging a resistive element with an ohmic characteristics in at least a part of a plurality of paths through which a current flows into the plurality of regions, and growing an electroplating film by electroplating simultaneously in the plurality of regions to form the electrodes of different thicknesses.

According to a still further aspect of the present invention, an electrostatic deflecting device comprises; a plurality of protruding electrodes of different film thicknesses in a plurality of regions on a substrate, and a film formed from a material different from that of the protruding electrode to have an ohmic characteristics, and arranged at a lower portion of at least one of the protruding electrodes, wherein a though hole for passing a charged particle is formed in the substrate between the protruding electrodes.

The electrolytic plating method according to the present invention can make the film thicknesses of plating films in a plurality of regions to be formed differ from each other or the same, by one time of electrolytic plating treatment. In addition, the electrolytic plating method can determine a ratio of the densities of the plating currents flowing into the plurality of the regions, by a resistance value of the above described electrically resistive element having the ohmic characteristics and the resistance value of the path through which an electrolytic plating current flows, and shows an effect which does not give restriction on voltage to be applied. In addition, an ohmic resistance exists in the path through which an electric signal is transmitted to a prepared structure, but a rectifying element does not exist there, and accordingly the path can transmit both of positive and negative electric signals. It is impossible when the rectifying element has been used for controlling the plating current.

Further features of the present invention will become apparent from the following description of exemplary embodiments with reference to the attached drawings.

### BRIEF DESCRIPTION OF THE DRAWINGS

FIGS. 1A, 1B, 1C, 1D, 1E and 1F are views according to a first embodiment or exemplary embodiment of the present invention.

FIGS. 2A and 2B are views illustrating an outline of an electrostatic deflecting device.

FIG. 3A is a view illustrating an electrode arrangement of electrolytic plating, and FIG. 3B is a view illustrating an equivalent circuit of the electrolytic plating.

FIGS. 4A, 4B, 4C and 4D are views according to a second embodiment of the present invention.

FIGS. 5A, 5B and 5C are views according to a third embodiment of the present invention.

### DESCRIPTION OF THE EMBODIMENTS

Preferred embodiments of the present invention will now be described in detail in accordance with the accompanying drawings.

It is important for the electrolytic plating method of the present invention to arrange an electrically resistive element having ohmic characteristics in at least one of a plurality of paths through which electrolytic plating currents flow into the plurality of the regions on a substrate, respectively, and simultaneously grow plating films in the plurality of regions by electrolytic plating. The structure, configuration, pattern, arrangement and the like of the resistive element having the ohmic characteristics may be flexibly determined according to the specification of the film thicknesses of the plating films formed in the plurality of the regions. In particular, the electrolytic plating method of the present invention can easily form an electrostatic deflecting device such as a blanking array which has protruding electrodes with different thicknesses in a plurality of regions on a substrate. The blanking array (BLA: Blanking Array) is a member for deflecting a charged particle beam. The blanking array is provided with an electrode for deflecting the charged particle beam, and a grounding electrode for shielding electric fields between adjacent apertures for passing the charged particles therethrough. The shielding effect is obtained by setting the grounding electrode so as to be higher than the deflecting electrode. It is desirable to form these electrodes with a plating method, but it is difficult to form electrodes having different heights from each other at a time, and it is conventionally popular to form the electrodes by two separated treatments. In contrast to this, the electrolytic plating method of the present invention for forming an electrostatic deflecting device includes: arranging a resistive element having ohmic characteristics in at least one of the paths through which electrolytic plating currents flow into the plurality of regions, respectively; differentiating the growing speeds of the plating films among the plurality of the regions from others; and thereby forming electrodes having different heights from each other. The blanking array is a device which has individual deflecting electrodes for each beam, and individually turns on/off the beams according to the drawing pattern based on blanking signals. When the beam is in an on state, voltage is not applied to the deflecting electrode of the blanking array. When the beam is in an off state, the voltage is applied to the deflecting electrode of the blanking array, and the charged particle beam is deflected. The charged particle beam which has been deflected by the blanking array is blocked by a stop aperture array which exists in a subsequent stage (downstream side), and the beam turns into the off state. When the beam is in the on state, the charged particle beam passes through the stop aperture array. By the operation of the blanking array which individually turns multiple beams on/off according to the drawing pattern, a desired pattern can be drawn on a wafer surface at high speed for a short period of drawing time.

Embodiments and exemplary embodiments of the electrolytic plating method and the like according to the present invention will be described below with reference to the drawings.

### First Embodiment

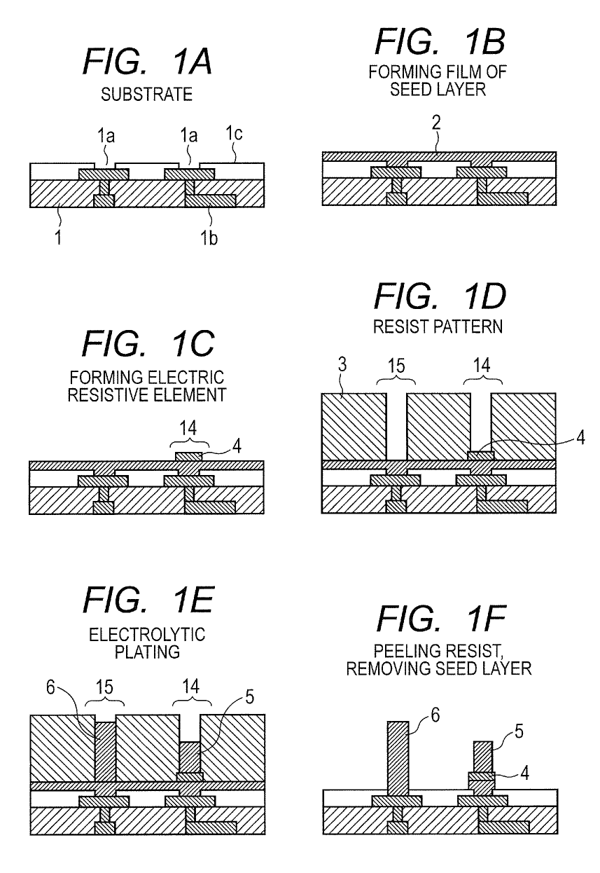

FIGS. 1A to 1F are sectional views corresponding to each step for manufacturing an electrostatic deflecting device of a first embodiment of the present invention. Firstly, in the present manufacturing method, an electrolytic plating seed layer 2 is formed on a substrate 1 illustrated in FIG. 1A, as is illustrated in FIG. 1B, and a resistive element 4 having ohmic characteristics is formed in a first region 14, as is illustrated in FIG. 1C. Next, a plating region is limited by a resist pattern 3, as is illustrated in FIG. 1D, and electrolytic plating treatment is conducted. Thereby, a plating film 5 is formed in a first region 14 and a plating film 6 is formed in a second region 15, as is illustrated in FIG. 1E. After that, as is illustrated in FIG. 1F, the resist pattern 3 and the electrolytic plating seed layer 2 are removed, and an electrostatic deflecting device is completed.

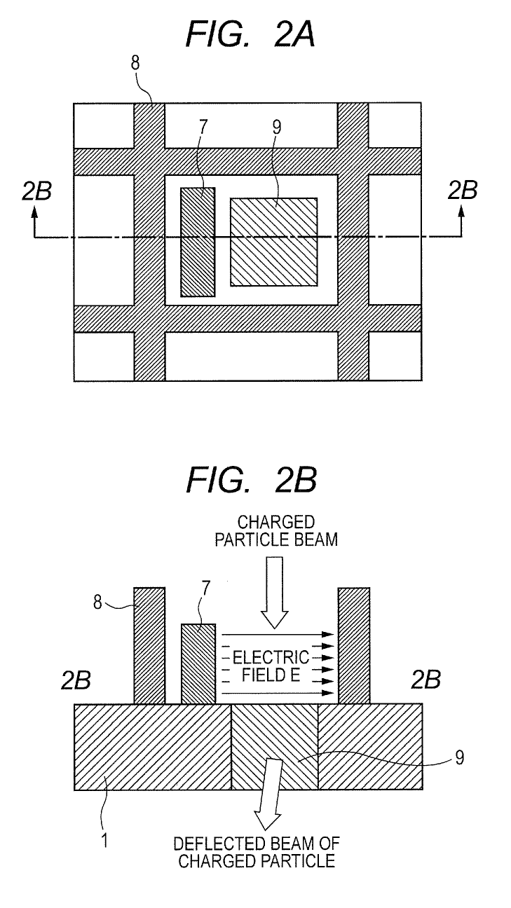

FIGS. 2A and 2B are views illustrating an outline of an electrostatic deflecting device which can be prepared by using a manufacturing method of the present embodiment. FIG. 2A is a plan view, and FIG. 2B is a sectional view. The present electrostatic deflecting device has a function of deflecting a charged particle beam which passes through a through hole 9 of the substrate 1, by an electrostatic field E which has been applied between a grounding electrode 8 and a deflecting electrode 7. As is illustrated in the sectional view of FIG. 2B, the grounding electrode 8 needs to be set so as to be higher than the deflecting electrode 7, in order to prevent the mutual interference of the electrostatic fields which have been generated by the adjacent deflecting electrode 7.

### Exemplary Embodiment 1

Next, Exemplary Embodiment 1 will be described below which is more specific and corresponds to the above described first embodiment. In the present exemplary embodiment, as is illustrated in FIG. 1C, a highly resistive film is used as a resistive element 4 which is arranged in a first region 14 and has ohmic characteristics. The process of manufacturing an electrostatic deflecting device of Exemplary Embodiment 1 will be described below with reference to FIGS. 1A to 1F. Here, as is illustrated in FIG. 1A, a silicon substrate 1 is used which has an integrated circuit for transmitting an electric signal to a deflecting electrode and a grounding electrode formed therein. The substrate 1 is provided with an electrode pad 1a for transmitting the electric signal to the deflecting electrode and the grounding electrode, a wire 1b and a passivation film 1c. The electrode pad 1a and the wire 1b are made from Cu, and the passivation film 1c is an SiN film.

Subsequently, as is illustrated in FIG. 1B, an electrolytic plating seed layer 2 is film-formed on the substrate by sputtering, in order to grow an electrolytic plating film on the substrate. The electrolytic plating seed layer 2 shall be made from Cu and have a film thickness of 1 μm. As is illustrated in FIG. 1C, a resistive element 4 having ohmic characteristics is formed in a portion which is a first region 14 on the electrolytic plating seed layer 2, and on which the deflecting electrode will be formed. In other words, the resistive element 4 is formed by forming a resistive coating film in at least one of the plurality of the regions. The resistive element 4 shall be an SnO₂ film and have a film thickness of 1 μm. Usable methods for patterning the SnO₂ film include an etching method and a lift-off method, and the techniques are not considered. Subsequently, as is illustrated in FIG. 1D, a resist pattern 3 is formed in which a portion that is the first region 14 and in which the deflecting electrode will be formed and a portion that is the second region 15 and in which the grounding electrode will be formed are opened.

Furthermore, as is illustrated in FIG. 1E, a plating film 5 which will function as the deflecting electrode is formed in the first region 14 and a plating film 6 which will function as the grounding electrode is formed in the second region 15, by electrolytic plating treatment. Here, the film thicknesses of the plating film 5 and the plating film 6 can be differentiated from each other by the action of the resistive element 4 having the ohmic characteristics. As is illustrated in FIG. 1F, the grounding electrode and the deflecting electrode can be formed by peeling a resist and removing a seed layer. In this way, the electrostatic deflecting device can be formed. In this electrostatic deflecting device, protruding electrodes with different thicknesses are provided in a plurality of regions on the substrate, a film which is made from a different material from that of the electrode and has the ohmic characteristics exists in at least one of lower portions of the electrodes, and a through hole for passing charged particles therethrough exists in the substrate between the plurality of the electrodes.

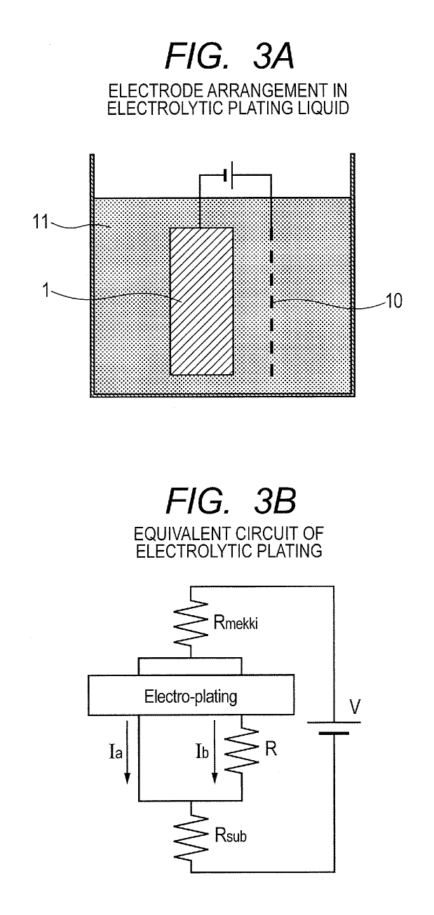

In order to describe the difference between the film thicknesses of the plating film 5 and the plating film 6 illustrated in FIG. 1E, a schematic view of electrolytic plating is illustrated in FIGS. 3A and 3B. As is illustrated in FIG. 3A, the substrate 1 and a counter electrode 10 are arranged in an electrolytic plating liquid 11, and the electrolytic plating is performed by applying a voltage between the substrate and the counter electrode. The counter electrode 10 has a grid shape, and is formed so that the plating liquid can pass through the counter electrode and the plating liquid 11 can be sufficiently supplied to the space between the substrate 1 and the counter electrode 10. In this configuration, the substrate 1 in which a plating region is limited by a resist pattern as illustrated in FIG. 1D is subjected to the electrolytic plating treatment. The electrolytic plating conditions are as described in the following (A) to (F).

(A) Composition of plating liquid (where any figure denotes content in 1 liter of plating liquid)
Copper sulfate: 100 g
Sulfuric acid: 250 g
Chlorine: 50 mg
Polyethylene glycol: 0.4 ml
Bis(3-sulphopropyl)disulphide disodium salt: 10 μl
   (B) Temperature of plating liquid: 25° C.
   (C) Liquid conductivity of plating liquid: 60 S/m
   (D) Pulse current density (average current density with respect to whole surface of substrate 1)
   Current density of 3.6 A/dm² in forward direction, current density of 10.8 A/dm² in reverse direction, period of time of 40 ms in forward direction and period of time of 2 ms in reverse direction
   (E) Distance between surface of substrate 1 and counter electrode 10: 100 μm
   (F) Thickness of grown plating film: 30 μm

At this time, an equivalent circuit of the electrolytic plating in this configuration can be illustrated as illustrated in FIG. 3B. The portion in which the resistive element 4 having the ohmic characteristics has been formed corresponds to resistor R in the equivalent circuit. A plating current which flows to the plating film 5 corresponds to Ib, and a plating current which flows to the plating film 6 corresponds to Ia. Each resistance value in the present exemplary embodiment is as described below.
Resistance Rsub of substrate=0.031Ω (in the case of center of 8-inch wafer)
Resistance Rmekki of plating liquid=1,042Ω
Resistance R for plating rate control=70Ω

Here, it has been supposed that the specific resistance of Cu is 1.68×10⁻⁸ Ωm, the size of the substrate is 8 inches, an electric current is supplied to the whole perimeter of a wafer, the specific resistance of SnO₂ film of the resistive element 4 is 0.014 Ωm, the growing region of the deflecting electrode 7 is 10 μm×20 μm, and the pitch of the pattern 3 is 40 μm.

Because the resistance of substrate is negligibly small, only the resistance Rmekki of the plating liquid and the resistance R for the plating rate control may be considered, and then, a ratio of the current densities can be expressed by Ib/Ia=R/(R+Rmekki). When the above described resistance values are substituted into the resistances, Ib/Ia equals to 0.937 and Ib is −6.3% with respect to Ia. In other words, the growing speed of the plating film 5 is −6.3% with respect to that of the plating film 6. Thereby, when the thickness of the plating film 6 which functioned as the grounding electrode was set at 30 μm, the thickness of the plating film 5 which functioned as the deflecting electrode became 28.1 μm, and the difference between the film thicknesses of the deflecting electrode and the grounding electrode could be set at 1.9 μm. When the thickness of 1 μm of the SnO₂ film of the resistive element 4 is considered, the height from the substrate surface to the upper surface of the deflecting electrode is calculated to be 29.1 μm, and a difference between the deflecting electrode and the grounding electrode is 0.9 μm.

As described above, the electrolytic plating method of the first embodiment and Exemplary Embodiment 1 can differentiate the heights of two types of electrodes to be formed by one time of electrolytic plating treatment, from each other. In addition, the electrolytic plating method arranges the resistive element only right under the plating film, and does not give influence on a peripheral pattern. In other words, the electrolytic plating method can arrange the resistive element only right under the pattern which is formed by the electrolytic plating, and accordingly the restriction on a pattern layout is eliminated. For information, an example of the electrolytic plating conditions was shown in the present exemplary embodiment, but the present exemplary embodiment shows that the ratio of the film thicknesses of the plating film 5 and the plating film 6 is determined by resistance R and resistance Rmekki, and does not limit the electrolytic plating conditions to which the present invention is applied. In addition, the material of the resistive element 4 is also an example, and does not limit the content of the present invention.

### Exemplary Embodiment 2

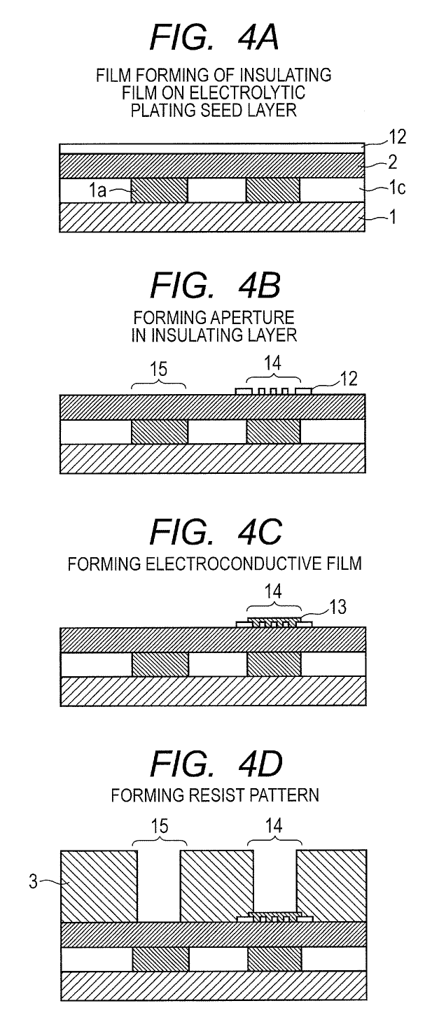

Exemplary Embodiment 2 of the present invention is an example of limiting a plating current flowing to a portion in which a deflecting electrode will be formed, by covering the portion with an insulating film and providing an aperture in the insulating film. Exemplary Embodiment 2 will be described below. FIGS. 4A to 4D illustrate steps of covering a portion that is a first region and in which a deflecting electrode will be formed, with an insulating film, and providing an aperture in the insulating film.

As is illustrated in FIG. 4A, the insulating film is formed on a substrate 1 on which the electrolytic plating seed layer 2 has been film-formed. The insulating film 12 shall be an SiO₂ film and have a film thickness of 50 nm. As is illustrated in FIG. 4B, the insulating film 12 is patterned. In the present exemplary embodiment, the insulating film 12 is left only in a plating region in which the plating current is desired to be limited. Here, the insulating film 12 is left in the first region 14, and the insulating film is not left in the second region 15. The plating region which is the first region 14 is set at 10×20 μm, and eight apertures having a size of 0.5 μm×0.5 μm are provided in the insulating film 12 in the plating region so that the aperture ratio is set at 1/100. A portion in which the insulating film 12 is patterned is a portion that is the first region 14 and in which the deflecting electrode will be formed. Next, as is illustrated in FIG. 4C, an electroconductive film 13 for growing the plating film thereon is formed on the insulating film pattern which has been formed in the first region 14. The electroconductive films 13 shall be an SnO₂ film and have a film thickness of 20 nm. The patterning method includes an etching method and a lift-off method, and the methods are not considered. In the present exemplary embodiment, the insulating film 12 provided with the aperture and the electroconductive film 13 constitute a resistive element which corresponds to the resistive element 4 in Exemplary Embodiment 1. Thus, in the present exemplary embodiment, an electrically resistive element having a desired resistance value is formed by covering at least one of a plurality of regions with the insulating film, providing at least one aperture in the insulating film, filling the aperture with the electroconductive film, and adjusting the total area of the aperture.

Next, as is illustrated in FIG. 4D, a resist pattern 3 is formed in which a portion that is the first region 14 and in which the deflecting electrode will be formed and a portion that is the second region 15 and in which the grounding electrode will be formed are opened, and the resultant substrate is subjected to the electrolytic plating treatment. The configuration and the conditions of the electrolytic plating are the same as those in Exemplary Embodiment 1. The resistance R in the equivalent circuit illustrated in FIG. 3B can be increased so as to decrease the electric current by limiting the total area of the aperture with the insulating film 12. Each resistance value in the present exemplary embodiment is as described below.
Resistance Rsub of substrate=0.031Ω (in the case of center of 8-inch wafer)
Resistance Rmekki of plating liquid=1,042Ω
Resistance R for plating rate control=140Ω

It has been supposed also here that the specific resistance of Cu is 1.68×10⁻⁸ Ωm, the size of the substrate is 8 inches, an electric current is supplied to the whole perimeter of a wafer, the specific resistance of SnO₂ is 0.014 Ωm, the growing region of the deflecting electrode is 10 μm×20 μm, and the pitch of the pattern 3 is 40 μm.

Because the resistance of the substrate is negligibly small, only the resistance Rmekki of the plating liquid and the resistance R for the plating rate control may be considered, and then, a ratio of the current densities can be expressed by Ib/Ia=R/(R+Rmekki). When the above described resistance values are substituted into the resistances, Ib/Ia equals to 0.882 and Ib is −11.8% with respect to Ia. In other words, the growing speed of the plating film which grows in the first region 14 illustrated in FIG. 4D is −11.8% with respect to the plating film which grows in the second region 15. Thereby, when the thickness of the grounding electrode which was the plating film that grew in the second region 15 was set at 30 μm, the thickness of the deflecting electrode which was the plating film that grew in the first region 14 became 26.4 μm, and the difference between the film thicknesses of the deflecting electrode and the grounding electrode could be set at 3.6 μm. When the thickness of 0.07 μm in total of the SiO₂ film 12 and the SnO₂ film 13 is considered, the difference between the heights of the SiO₂ film 12 and the SnO₂ film 13 from the surface of the substrate is 3.5 μm.

As described above, the electrolytic plating method of Exemplary Embodiment 2 could differentiate the film thicknesses of the plating films which grew in two regions from each other, by one time of electrolytic plating treatment. In addition, the electrolytic plating method arranges the resistive element with the use of the insulating film only right under the plating film, and does not give influence on a peripheral pattern. The material and the thickness of the insulating film and the electroconductive film are an example also here, and do not limit the content of the present invention.

### Exemplary Embodiment 3

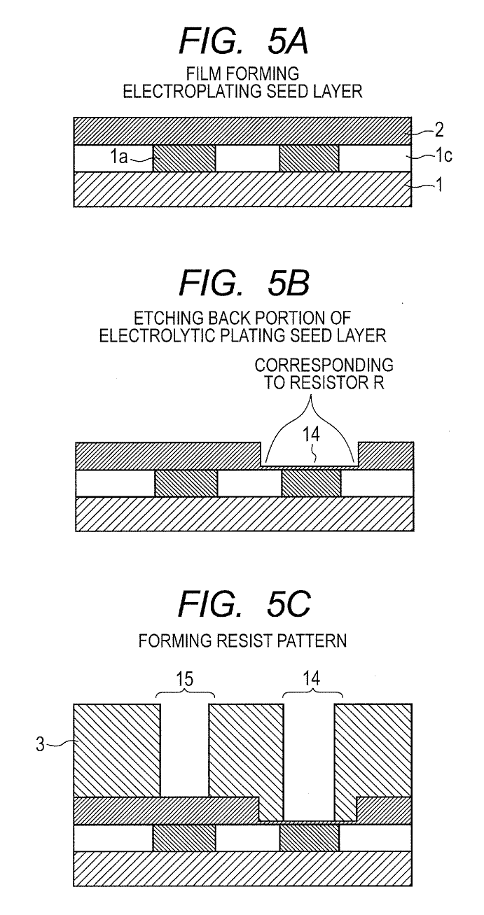

Exemplary embodiment 3 of the present invention is an example of limiting a plating current flowing into a region in which a deflecting electrode will be formed, by thinning an electrolytic plating seed layer existing in the region. Exemplary Embodiment 3 will be described below. FIGS. 5A to 5C illustrate steps of thinning the electrolytic plating seed layer existing in the region in which the deflecting electrode will be formed.

As is illustrated in FIG. 5A, the electrolytic plating seed layer 2 is film-formed on a substrate 1. As is illustrated in FIG. 5B, the electrolytic plating seed layer 2 is thinned by etching only in a region that is a first region 14 and in which a deflecting electrode will be formed. Next, as is illustrated in FIG. 5C, a resist pattern 3 is formed, and the resultant substrate is subjected to electrolytic plating treatment. At this time, an electric current is limited in a portion that is the first region 14 and in which the seed layer is thin, and the resistance R in the equivalent circuit illustrated in FIG. 3B becomes large. In other words, the electric current Ib illustrated in FIG. 3B becomes small, and the growing speed of the plating film in the first region 14 becomes smaller than the growing speed of the plating film in the second region 15. Thus, in the present exemplary embodiment, the substrate is an insulative substrate, and an electrically resistive element is formed by thinning at least one seed layer in a plurality of regions, in the seed layer provided on the insulative substrate so that a plating current is supplied therethrough. The electrolytic plating method in the present exemplary embodiment also has a similar effect to the electrolytic plating method according to Exemplary Embodiment 1.

### Exemplary Embodiment 4

Exemplary Embodiments 1 to 3 have aimed at differentiating the thickness of a plating film in a certain region from that in another region. A method is thought that decreases the distribution of film thicknesses in the plane of a substrate by applying the above methods, which is produced when a usual electrolytic plating is performed. Suppose that when the usual electrolytic plating has been performed, there exists a region A in which a plating film grows at a certain speed, and on the other hand, there exists a region B in which the plating film grows at a speed twice as large as the certain speed. If the growing speed in the region B can be reduced to be a half (which is actually possible) by applying any one method of the above described exemplary embodiments to the region B, the growing speeds of the plating films in the region A and the region B become equal. By being applied to all plating regions in the plane of the substrate, the method can show an effect of almost equalizing the growing speeds of the plating films in all plating regions in the plane of the substrate.

Thus, in the present exemplary embodiment, the resistive element is formed on the substrate on which the growing speed of the plating film does not become uniform with an ordinary method, so as to have a predetermined configuration or structure and a pattern, and the growing speed of the plating film in the plane of the substrate is almost uniformized. Here, the growing speed of the electrolytic plating film can be corrected so that the distribution is cancelled, and accordingly, the distribution of the growing speeds of the electrolytic plating film can be almost uniformized in the plane. If this technology is further generalized and the resistive elements having an adequate configuration or structure are arranged in an adequate pattern on the surface of the substrate, the plating film having a desired distribution of the film thicknesses can be formed on the substrate.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-164773, filed Jul. 27, 2011, which is hereby incorporated by reference herein in its entirety.

What is claimed is:

1. An electrolytic plating method for forming a plating film of a predetermined thickness in a plurality of regions on a substrate comprising steps of:
arranging a resistive element with an ohmic characteristics in at least a part of a plurality of paths through which an electrolytic plating current flows into the plurality of regions; and
growing an electroplating film by electroplating simultaneously in the plurality of regions.

2. The electrolytic plating method for forming an electrostatic deflecting device having electrodes of different thicknesses in a plurality of regions on a substrate comprising steps of:
arranging a resistive element with an ohmic characteristics in at least a part of a plurality of paths through which a current flows into the plurality of regions; and
growing an electroplating film by electroplating simultaneously in the plurality of regions to form the electrodes of different thicknesses.

3. The electrolytic plating method according to claim 1, wherein
during the step of growing the electroplating film, in at least two of the plurality of regions, the growing speeds of the electroplating film therein are different from each other.

4. The electrolytic plating method according to claim 1, wherein
the step of growing the electroplating film comprises steps of:
forming, on the substrate, a seed layer for growing the electroplating film therefrom;
forming, on the seed layer, a resist pattern for limiting a region for the electroplating;
forming the electroplating film corresponding to the resist pattern; and
removing the resist pattern and the seed layer.

5. The electrolytic plating method according to claim 1, wherein
at least one of the plurality of regions is covered with an insulating film, an aperture is formed in the insulating film, the aperture is filled with a conductive film, and a total area of the aperture is adjusted so that the resistive element has a predetermined resistance value.

6. The electrolytic plating method according to claim 1, wherein
the substrate is an insulating substrate, a seed layer is provided on the insulating substrate for supplying the electrolytic plating current, and a thickness of the seed layer in at least one of the plurality of regions is reduced to form the resistive element.

7. The electrolytic plating method according to claim 1, wherein
a resistive film is formed to cover least one of the plurality of regions.

8. The electrolytic plating method according to claim 7, wherein
the resistive film is formed between the substrate and the plating film.

9. The electrolytic plating method according to claim 8, wherein
the resistive film is SnO2 film.

10. The electrolytic plating method according to claim 2, wherein
the electrodes of different thicknesses are a deflecting electrode and a grounding electrode between which a through hole for passing a charged particle is formed in the substrate.

11. The electrolytic plating method according to claim 2, wherein,
on the substrate having a property of non-uniformly growing the plating film thereon under a normal condition, the resistive element formed in a predetermined configuration and pattern, to make uniform a growing speed of the plating film.

12. An electrostatic deflecting device comprising:
a plurality of protruding electrodes of different film thicknesses in a plurality of regions on a substrate; and
a film formed from a material different from that of the protruding electrode to have an ohmic characteristics, and arranged at a lower portion of at least one of the protruding electrodes, wherein
a though hole for passing a charged particle is formed in the substrate between the protruding electrodes.

13. The electrostatic deflecting device according to claim 12, wherein
the protruding electrodes include a deflecting electrode and a grounding electrode, and
the deflecting electrode is supplied with a voltage equal to or higher than a voltage of the grounding electrode.

14. The electrostatic deflecting device according to claim 13, wherein
the grounding electrode has a height from the substrate higher than that of the deflecting electrode.

15. The electrostatic deflecting device according to claim 14, wherein
the grounding electrodes are arranged in a matrix, and
the deflecting electrode and the through hole are arranged in a region surrounded by grounding electrodes.

16. The electrostatic deflecting device according to claim 13, wherein
the deflecting electrode is supplied with a voltage based on a signal according to a scribing pattern, to control ON/OFF of the charged particle according to the scribing pattern.
